(19) United States
(12) Patent Application Publication
(10) Pub. No.: US 2021/0300107 A1
(43) Pub. Date: Sep. 30, 2021

(54) Artificial Landscape Stones

(71) Applicant: Hon Je Ling, Hacienda Heights, CA (US)

(72) Inventor: Hon Je Ling, Hacienda Heights, CA (US)

(21) Appl. No.: 16/938,128

(22) Filed: Jul. 24, 2020

Related U.S. Application Data
(60) Provisional application No. 63/002,438, filed on Mar. 31, 2020.

(51) Int. Cl. B44C 5/06; B44F 9/04

(52) U.S. Cl. CPC B44C 5/06; B44F 9/04

(57) ABSTRACT

A relative lightweight and size-adjustable artificial landscape stone is described herein. The artificial stone is preferably formed of a suitable plastic material having a relatively low density, and has the exterior appearance of a naturally occurring stone. The artificial stones allow users to easily transport the plastic stones to different locations in a garden for aesthetic purposes. The lightweight artificial stones are preferably comprised of two separate halves which can be joined by the user for installation. The invention also includes a stake on a bottom section of the plastic stone to anchor the plastic stone into the ground. The lightweight artificial stone utilize durable and weather-resistant plastic materials to ensure that the stones maintain their natural look for prolonged periods of time.

### CROSS-REFERENCE TO RELATED APPLICATION

The present application claims priority to, and the benefit of, U.S. Provisional Application No. 63/002,438, which was filed on Mar. 31, 2020 and is incorporated herein by reference in its entirety.

### BACKGROUND

The present invention relates generally to the field of landscape decor such as stones. More specifically, the present invention relates to lightweight artificial landscape stones for decorating gardens, paths, artificial hillock, swimming pools, aquariums and the like. The artificial plastic landscape stones, in one embodiment, may be comprised of at least two plastic pieces connected with a stake at the bottom of the stone structure in order to be anchored in the ground. The plastic landscape stone is preferably hollow inside and therefore lightweight, which allows a user to easily transport the plastic stones to different locations in a garden for aesthetic purposes. Accordingly, the present specification makes specific reference thereto. However, it is to be appreciated that aspects of the present invention are also equally amenable to other like applications, devices and methods of manufacture.

Generally stated, a garden is a planned place on personal property or in a public area, usually outdoors, set aside for the cultivation and display of ornamental and flowering plants and other objects typically found in nature. Other accessories in a garden typically include rocks, stones or pebbles, fountains and decorative paving. The garden can incorporate both natural and man-made materials.

Natural materials such as natural stones, are often placed in a garden for various purposes such as for an aesthetic look, for decoration, for creating a boundary for a specified area such as plants, trees, fountains or around a pool. However, the natural stones placed in a garden or other outdoor areas are often extremely heavy and difficult to transport and install. Garden owners alone often have difficulty moving these heavy stones and have to pay for assistance whenever the stones are to be transported from one place to the other. For example, if people want to adjust the look of their garden, assistance and hence additional cost may be required to transport and install the stones. Larger, bulky stones can limit garden design, and leave people disappointed with the overall appearance of their garden.

In many regions, natural stones are not available and are oftentimes imported from different parts of the world. Natural stones are often costly and their inaccessibility typically increases the shipping and labor cost, thereby inflating the cost of creating a garden. Also, the size and the shape of the natural stones are often fixed, and cannot be adjusted to better interact or blend in with the settings of different items in the garden and/or the wants and needs of the user. Therefore, a stone having an adjustable size is desired.

Existing natural stones are often standalone units, and when larger stones are desired and need to be transported, the larger size stones are packaged in a larger container and the size and shape of the larger stones crate many voids in the packaging, which is both inconvenient and inefficient in terms of packaging and expense. Further, larger landscaping stones tend to be heavy and difficult to move, and the act of doing so may result in injury to the user (e.g., back injuries, strained muscles, and the like).

Furthermore, artificial or man-made materials such as plastic grasses, grass carpets, fountains, etc. exist in the state of the art, which are often utilized in the gardens and indoor and outdoor decoration. Such artificial garden decorative items are lightweight and easy to move from one place to another to change the aesthetic look and give a completely different design for gardens. However, an alternative to the natural heavy weight landscaping stones does not exist, thereby causing inconvenience to the user.

Consequently, there exists a long felt need in the art for lightweight stones which can be utilized to decorate gardens, swimming pools, paths, etc. There is also a long felt need in the art for stones which can be easily transported from one place to another without the need for additional assistance and expensive labor charges. Further, there is also a long felt need in the art for highly structured artificial stones for diverse decorations that solve related packing and transportation problems, and for a landscaping stone structure with an adjustable height mechanism to fulfil different user needs and requirements. There is also a long felt need for artificial landscaping stones that do not limit garden design, and that leave users satisfied with the overall appearance of their garden. Additionally, there is a long felt need in the art for a stone structure with a securing mechanism to anchor the stones in a desired location, and so that they remain secure in a particular design or position. Finally, there is a long felt need in the art for an inexpensive and efficient method of manufacturing a complete artificial stone in a single injection molding operation.

The subject matter disclosed and claimed herein, in one embodiment thereof, comprises lightweight landscape stones that may be constructed out of plastic, designed to look like natural stones (but with minimal weight), and that allow users to easily transport the stones to different locations in a garden for aesthetic purposes and at minimal expense. The plastic landscape stones of the present invention include a structure with an appearance of a natural stone and that is attached to a stake positioned at the bottom of the stone structure in order to anchor the stone structure to the ground. The landscape stone utilizes durable, weather-resistant materials to ensure that the stones maintain their natural look for a prolonged period of time. Further, the landscape stones are hollow and, therefore, relatively light and are easily transportable. The plastic landscape stones can be manufactured with a separate layered structure to adjust the height or size of the stone. Finally, the landscaping stones of the present invention are manufactured as multi-structured units that a user may utilize to assemble the landscaping stone while positioning the stone in the garden, thereby reducing packing and transportation problems of standalone stone structures.

In this manner, the relatively lightweight landscape stones of the present invention accomplish all of the forgoing objectives, and provide a relatively quick and convenient solution for decorating a garden or any outdoor space with natural looking stones. The unique plastic landscape stone structure secures the plastic stones on a surface and protects them from displacement in adverse weather conditions (e.g., high winds, heavy snowfall, etc.). The unique plastic stone design further features an assembling structure which enables the stone components to be efficiently packaged and shipped, thereby reducing the existing packing and transportation issues described above. The improved lightweight landscape stones of the present invention are also stable, durable and easy to install, thereby reducing costs and improving overall efficiencies. Furthermore, the landscaping stone structure provides a height-adjusting mechanism, thereby enabling a user to adjust the stone height or size to satisfy the wants and needs of the user. The plastic landscape stones are also hollow, thereby making the same relatively lightweight and easily repositionable in a landscaping setting. Moreover, the artificial landscape stones of the present invention utilize durable, weather-resistant plastic materials to ensure that the stones maintain their natural look for a prolonged period of time. Finally, the present invention provides a method to easily and efficiently produce or manufacture a complete plastic stone by a single injection molding process.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one embodiment thereof, comprises a relatively lightweight landscaping stone that is designed to look like a natural stone (but with minimal weight), thereby allowing a user to easily transport the plastic stone to different locations in a garden or other outdoor place for aesthetic purposes. The lightweight landscape stones of the present invention also include a stake arrangement on the bottom section of the plastic stones to anchor the landscape stones into the ground. Further, the landscape stones, in one embodiment, utilize durable and weather-resistant plastic materials to ensure that the stones maintain their natural look for prolonged periods of time.

In one embodiment, each landscape stone of the present invention is a two-piece plastic decoration article that functions as a natural stone, and that has an exterior surface that resembles a natural stone in appearance. More specifically, the plastic landscape stone comprises of two-piece structure connected with a stake at the bottom to be anchored into the ground. The head of the stake is concealed in a separate compartment within the stone structure. Additionally, the plastic stones are hollow and relatively lightweight, and therefore can be easily transported to different locations in a garden without assistance and without incurring significant labor expense. Further, a coating on the stone surface can be customized to mimic natural stones in color and appearance.

In an embodiment of the present invention, a complete plastic landscape stone is manufactured via injection molding in a single operation. The plastic landscape stone structure may have an optional stake or stick structure to anchor the stone to the ground. Two half stone structures are melted completely by the moulding injection mechanism to form a completed plastic or artificial landscape stone structure. The formed complete stone is hollow and lightweight. Such manufacturing processes are suitable for most smaller sized stones.

In another embodiment of the present invention, a method for manufacturing large sized stone is disclosed. Such large sized artificial plastic landscape stones are manufactured as separate components, such as a first half, a second half and a stake or a stick. Once manufactured, the separate components are more efficiently packaged and easily transported to the end user. Upon receipt, the user can assemble the different stone components to form a complete large sized plastic landscape stone structure. The disclosed method minimizes the amount of packaging otherwise required to ship larger stones, and eliminates many of the transportation problems described above.

In yet another embodiment of the present invention, a unique artificial stone structure design in disclosed. The stone structure is manufactured as separate components comprised of a plastic stone body, a plate and a stick, by utilizing a moulding injection method. The separate components of the stone can be easily and quickly assembled by a user and can be utilized to decorate gardens, pathways, swimming pools, and the like.

In a further embodiment of the present invention, an adjustable height artificial plastic landscape stone is disclosed. The adjustable height plastic landscape stone comprises a plastic stone body and a layer that may be used to adjust the height or size of the stone. Multiple layers can be utilized in a stone structure and can be connected together using a waterproof adhesive to increase the height of the plastic stone for decoration purposes and/or to suit user need and/or preference. For example, in one embodiment, the present invention provides an adjustable height landscaping stone comprising a stone body having an outer surface and an inner surface, a first and a second plate, a first layer having a top and a bottom face such that said first layer is placed between said first and second plate; and a stick attached to said second plate on said bottom face of said first layer, wherein said stone body is placed over said first plate on said top face of said first layer.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one possible embodiment of the relatively lightweight plastic landscape stones of the present invention installed in a ground surface in accordance with the disclosed architecture.

FIG. 2a illustrates a perspective, partially exploded interior view of one possible embodiment of a landscaping stone of the present invention in accordance with the disclosed architecture.

FIG. 2b illustrates a perspective, partially exploded side view of one possible embodiment of a landscaping stone of the present invention in accordance with the disclosed architecture.

FIG. 2c illustrates a perspective side view of one possible embodiment of a landscaping stone of the present invention in accordance with the disclosed architecture.

FIG. 3a illustrates a perspective, partially exploded interior view of one possible embodiment of a landscaping stone of the present invention in accordance with the disclosed architecture.

FIG. 3b illustrates a perspective, partially exploded side view of one possible embodiment of a landscaping stone of the present invention in accordance with the disclosed architecture.

FIG. 3c illustrates a perspective side view of one possible embodiment of a landscaping stone of the present invention having a stake in accordance with the disclosed architecture.

FIG. 4a illustrates a perspective view of one possible embodiment of the relatively lightweight plastic landscape stones of the present invention having a plate installed therein in accordance with the disclosed architecture.

FIG. 4b illustrates a perspective view of one possible embodiment of the plate in accordance with the disclosed architecture.

FIG. 4c illustrates a perspective view of one possible embodiment of the stone mounting support stick in accordance with the disclosed architecture.

FIG. 4d illustrates a top perspective view of one possible embodiment of a landscaping stone of the present invention in accordance with the disclosed architecture.

FIG. 4e illustrates a top perspective view of one possible embodiment of a landscaping stone bottom section of the present invention in accordance with the disclosed architecture.

FIG. 4f illustrates a top perspective view of one possible embodiment of a landscaping stone mounting support stick of the present invention in accordance with the disclosed architecture.

FIG. 4g illustrates a side perspective view of one possible embodiment of a landscaping stone of the present invention in accordance with the disclosed architecture.

FIG. 5a illustrates a side perspective and partially exploded view of one possible embodiment of a landscaping stone of the present invention having an additional plastic layer and plates in accordance with the disclosed architecture.

FIG. 5b illustrates a top perspective view of one possible embodiment of an additional plastic layer of the present invention in accordance with the disclosed architecture.

FIG. 5c illustrates a side perspective view of one possible embodiment of a landscaping stone of the present invention having an additional plastic layer and plates in accordance with the disclosed architecture.

FIG. 5d illustrates a side perspective view of one possible embodiment of a landscaping stone of the present invention having a plurality of additional plastic layers and plates in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof.

As noted above, there exists a long felt need in the art for lightweight stones which can be utilized to decorate gardens, swimming pools, paths, etc. There is also a long felt need in the art for artificial stones which can be easily transported from one place to another without any need for assistance, and without incurring significant labor charges. Additionally, there is also a long felt need in the art for highly structured artificial stones having diverse decorations, and a need in the art for a stone structure which solves existing packaging and transportation related problems. There is also a long felt need in the art for an artificial stone structure comprised of an adjustable height mechanism to satisfy user need and/or preference, and that does not limit garden design. Finally, there is a long felt need in the art for an artificial stone structure with at least one securing mechanism to anchor the stone structure to the ground so that it retains its intended position and is not disturbed by adverse weather, such as strong winds and the like.

The innovative product of the present invention features relatively lightweight landscaping stones designed to look like natural stones (but with minimal weight), and that allows users to easily transport and reposition the artificial stones to different locations in a garden or other landscaping setting for aesthetic purposes. The landscaping stones of the present invention potentially include a stake arrangement on a bottom section of the artificial stones to anchor the landscaping stones into the ground. The stones are preferably hollow and comprised of durable, weather-resistant materials to ensure that the artificial stones maintain their natural look for prolonged periods of time even when exposed to the elements (e.g., rain, snow, sleet, wind, sunlight, etc.). Further, in one embodiment, the landscaping stones may be comprised of a plurality of layers which can be utilized to adjust the height or size of the artificial stones.

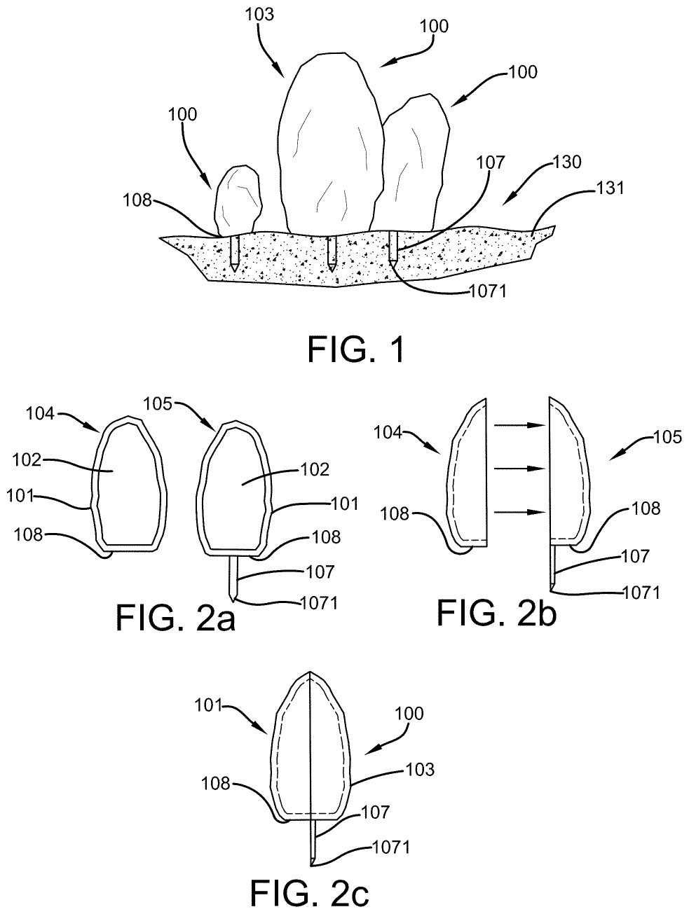

Referring initially to the drawings, FIG. 1 illustrates a perspective view of one possible embodiment of the relatively lightweight artificial landscape stones 100 of the present invention installed in a ground surface 130 in accordance with the disclosed architecture. Each of the artificial landscaping stones 100 is a two-piece decorative stone having the appearance of a naturally occurring stone, and is comprised of a first half 104 and a second half 105 which can be permanently or removably adhered together by a fastener mechanism, adhesive—permanent or resealable etc., or can be assembled by a user to form a single stone structure 100 and installed along a ground surface 130. An outer surface 103 of the artificial plastic stone 100 features a natural stone appearance or design.

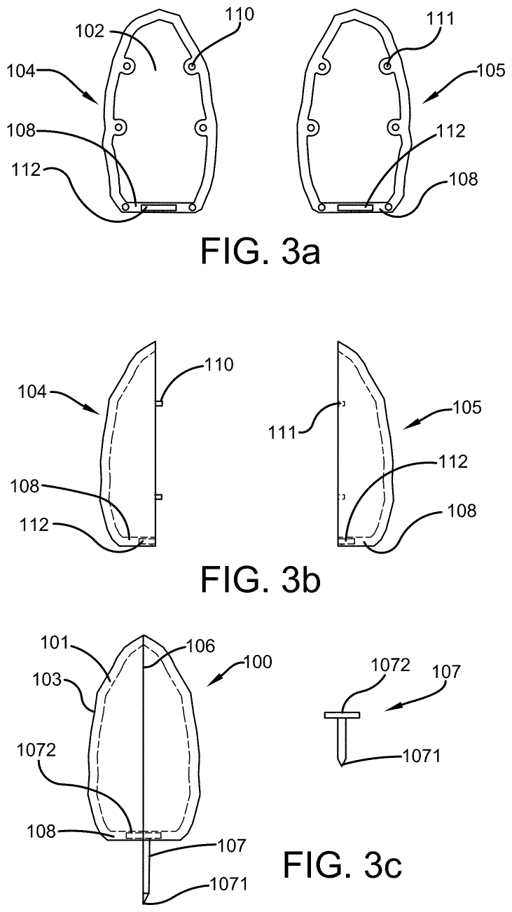

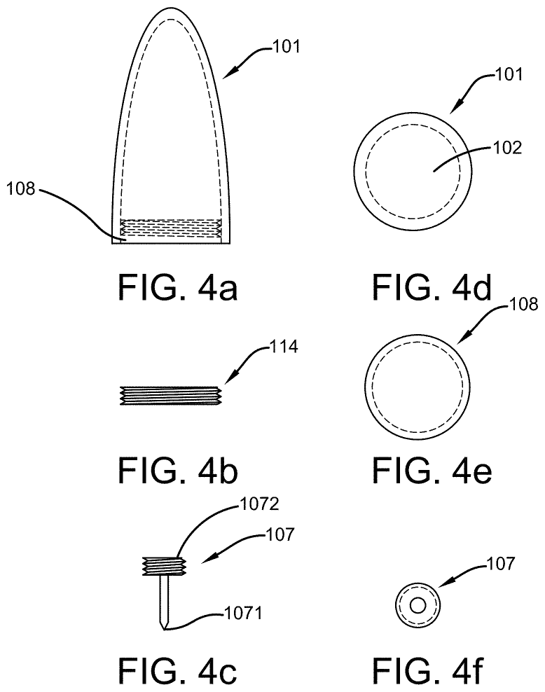

As best illustrated in FIGS. 2 through 5, the two stone halves 104, 105 may be supported via a stone mounting support stick 107 located along a bottom section 108 of one of either the first half 104 or the second half 105 of stone 100 in order to anchor the stone 100 into the garden or other ground surface 130. More specifically, the mounting support stick 107 has a stick tapering end 1071, which penetrates the soil 131 of the ground surface 130, as best shown in FIG. 1. Further, as best shown in FIG. 3c, a stick securing end 1072 of the stone mounting support stick 107 is concealed in a separate stick head compartment 112 that may be present in both the first half 104 and the second half 105 of the artificial stone 100. In one embodiment of the present invention, the artificial landscaping stones 100 are substantially hollow and comprise an outer stone body 101 that defines an internal hollow space 102. Because the artificial landscaping stones 100 are hollow, they are relatively lightweight (e.g., weighing only a few pounds) and are easily repositionable to different locations in a garden, pathway or other landscape setting, with minimal effort or risk of injury to the user.

In one an embodiment of the present invention, the artificial landscaping stones 100 are manufactured of a durable and weather resistant plastic including, but not limited to, one or more of a polyethylene, hard Polyvinyl chloride (PVC), polypropylenes, polyurethanes, epoxy resins, unsaturated polyester resins, acrylates, methacrylates, and the like. However, it is also contemplated that other materials can be used such as rubber or other suitable materials. Further, the artificial landscape stones 100 are preferably coated to protect, as well as decorate, the outer surface 103 of the artificial stone 100. Coating of the outer surface 103 of the artificial stone 100 can be accomplished using one or more of the following non-exhaustive list of coatings, namely architectural coatings, powder coatings, enamels, lacquers, etc. Further, in one embodiment, the artificial stone 100 may be coated with a luminescent powder such that the artificial stone 100 glows in the dark and at night, thereby giving an attractive appearance to the artificial stones 100. Nonetheless, it is important to note that the artificial stones 100 may be manufactured from materials other than plastic.

The artificial stones 100 of the present invention are preferably manufactured by injection molding and in a single operation. More specifically, a plastic material is melted in an injection molding machine and then injected into a mold in the shape of the stones 100, wherein the plastic then cools and solidifies into the final stone 100. The method of injection molding is typically used to produce relatively thin-walled plastic parts for a wide variety of applications, one of the most common being plastic housings.

FIG. 2a illustrates a perspective, partially exploded interior view of one possible embodiment of a landscaping stone 100 of the present invention in accordance with the disclosed architecture and comprised of first and second half pieces 104, 105. More specifically, each of half pieces 104, 105 is further comprised of an outer stone body 101 defining an interior hollow space 102 and having an outer stone surface 103 in the shape and coloration of that of a naturally occurring stone. Additionally, one of half pieces 104, 105 (second half 105 in FIGS. 2a-c) further comprises a stone mounting support stick 107 for anchoring the artificial stone 100 to a garden or ground surface 130.

Stone mounting support stick 107 is further comprised of a stick tapering end 1071 and a stick securing end 1072, wherein the stick tapering end 1071 of stick 107 is sharp enough to be easily inserted into the ground 130 by a user (not shown) with minimal effort, and the stick securing end 1072 is the portion of stick 107 removably secured to artificial stone 100, as described more fully below. Stone mounting support stick 107 may be manufactured of any relatively lightweight material such as, but not limited to, plastic, wood, or any sharp metal to firmly anchor the stone 100 to the ground surface 130.

FIG. 2b illustrates a perspective, partially exploded side view of one possible embodiment of a landscaping stone 100 of the present invention in accordance with the disclosed architecture and wherein the first half 104 is about to be joined to the second half 105. FIG. 2c illustrates a perspective side view of the landscaping stone 100 of FIG. 2c, wherein the first and second halves 104, 105 are joined together (permanently or temporarily) and supported by stone mounting support stick 107. Artificial stones 100 may be manufactured with or without stone mounting support stick 107 at a bottom surface 108 of the stone 100, and may be manufactured via injection molding in just one operation by melting and joining the first half 104 of stone 100 with the second half 105 of stone 100. The artificial stones 100 produced by this method are typically relatively small in size, hollow, and immediately ready for installation.

FIG. 3a illustrates a perspective, partially exploded interior view of an alternative embodiment of a landscaping stone 100 of the present invention in accordance with the disclosed architecture, and FIG. 3b illustrates a perspective, partially exploded side view of landscaping stone 100. In this embodiment, first half 104 and second half 105 may be manufactured as separate parts to be assembled by a user during installation, and after packaging and transportation of the artificial stones 100, thereby enabling the stones 100 to be more efficiently packaged and shipped.

As described above, each of half pieces 104, 105 is further comprised of an outer stone body 101 defining an interior hollow space 102 and having an outer stone surface 103 in the shape and coloration of that of a naturally occurring stone. Additionally, in this embodiment, artificial stone 100 is further comprised of a standalone stone mounting support stick 107 for anchoring the artificial stone 100 to a garden or ground surface 130.

FIG. 3c illustrates a perspective side view of the landscaping stone 100 of FIGS. 3a and 3b and having a stone mounting support stick 107 comprised of a head securing end 1072 and a tapering end 1071, which may be firmly stuck into a ground surface. More specifically, the two half pieces 104, 105 are assembled together and the stick head securing end 1072 is attached to a stick head compartment 112 provided in the half piece structures 104 and 105. The stick head compartment 112 is a hollow structure formed inside the stone bottom section 108 of half pieces 104, 105, and in a size of the stick securing end 1072, such that the mounting stick 107 can be easily secured inside the stick head compartment 112 of the artificial stone 100. Once the mounting stick 107 is secured inside the stick head compartment 112, the stone 100 can be easily anchored to a ground surface 130 by utilizing the stick tapering end 1071.

Various sized artificial stones 100 manufactured and shipped as separate components can be more easily packaged and transported than a unitary artificial stone because of the reduction in packaging voids. More specifically, separate components, such as the first half 104, the second half 105, and the stone mounting support stick 107, may be manufactured separately and as individual components are comparatively smaller in size and capable of nesting during the packaging process. Further, upon receipt, the various components of artificial stones 100 may be easily assembled by the user. For example, as best shown in FIGS. 3a through c, first half 104 may further comprise a plurality of male connectors 110, and the second half 105 may comprise a plurality of corresponding female slots 111 for mating engagement with the male connectors 110. As best shown in FIG. 3c, the male connectors 110 and the female slots 111 are preferably provided on a joint portion 106 of the first and second halves 104, 105, and the placement of the male connectors 110 and female slots 111 can be on either of the halves 104, 105. The users can assemble the parts 104 and 105 to form the artificial plastic stone 100 by locking the male connectors 110 into the female slots 111 and further install the stone 100 in a garden or outdoor space, as explained above.

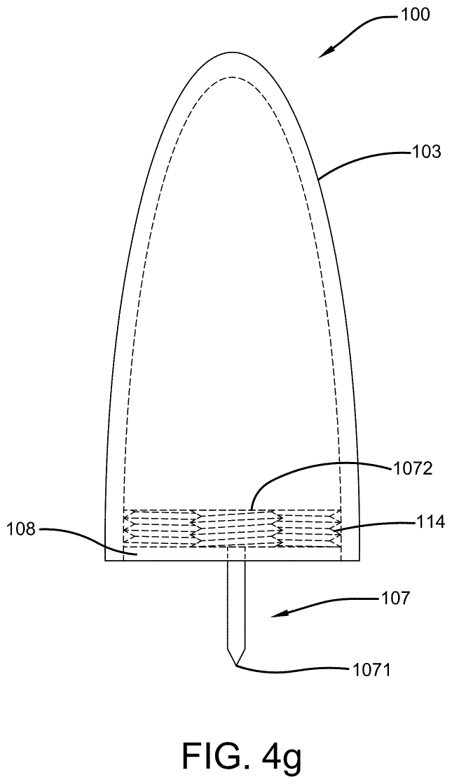

FIG. 4a illustrates a perspective view of one possible embodiment of a relatively lightweight landscape stone 100 of the present invention having an outer stone body 101, a stone bottom section 108, and a plate 114 installed therein in accordance with the disclosed architecture, and FIG. 4b illustrates a perspective view of one possible embodiment of the plate 114, which is preferably threaded as shown for mating engagement with outer stone body 101. FIG. 4c illustrates a perspective view of one possible embodiment of the stone mounting support stick 107 in accordance with the disclosed architecture, and having a stick tapering end 1071 and a stick securing end 1072, as described above.

FIG. 4d illustrates a top perspective view of one possible embodiment of a landscaping stone 100 of the present invention having an outer stone body 101 that defines an internal hollow space 102, which reduces the overall weight of the landscaping stone 100, the benefits of which are described above. FIG. 4e illustrates a top perspective view of one possible embodiment of the landscaping stone bottom section 108, and FIG. 4f illustrates a top perspective view of one possible embodiment of the landscaping stone mounting support stick 107. FIG. 4g illustrates a side perspective view of one possible embodiment of a fully assembled landscaping stone 100 of the present invention fully assembled and comprised of an outer stone body 101 that defines an internal hollow space 102, an outer surface of the stone 103 that may be colored and/or textured to give the appearance of naturally occurring stone, a stone mounting support stick 107 having a stick tapering end 1071 and a stick securing end 1072, a stone bottom section 108, and a plate 114 positioned within the internal hollow space 102 and immediately adjacent to the stone bottom section 108. More specifically, and as best shown in FIGS. 4c and 4g, stick securing end 1072 may be threaded to matingly engage with a threaded opening in plate 114.

While FIG. 4g depicts a fully assembled landscaping stone 100 of irregular shape, it should be appreciated that its various components may be individually manufactured and packaged more efficiently to reduce the amount of packaging voids otherwise present with the packaging of relatively large and irregularly shaped articles, thereby reducing the amount of packaging materials required and the associated shipping costs. Upon receipt, a user can easily assemble the parts to form an artificial plastic stone 100 by joining, for example, the outer stone body 101, the plate 114 and the stone mounting support stick 107, and installing the assembled landscaping stone 100 in a garden or other outdoor space.

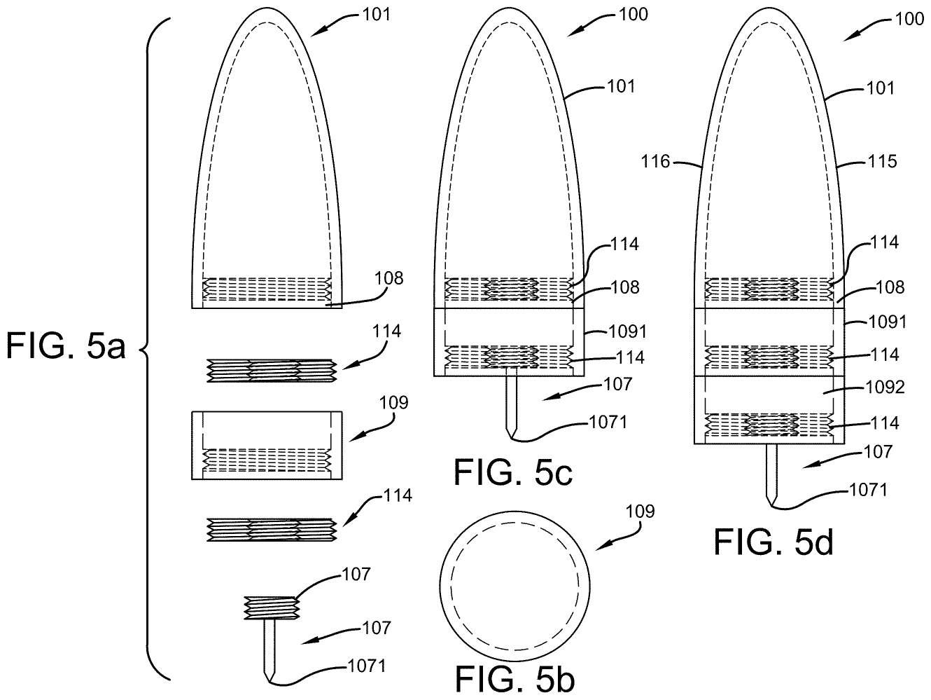

Generally stated, FIG. 5 illustrates yet another embodiment of an adjustable height landscape stone 100 having multiple stackable layers 109. More specifically, FIG. 5a illustrates a side perspective and partially exploded view of one possible embodiment of landscaping stone 100 comprised of an outer stone body 101 that defines an internal hollow space 102, an outer surface of the stone 103 that may be colored and/or textured to give the appearance of naturally occurring stone, a stone mounting support stick 107 having a stick tapering end 1071 and a stick securing end 1072, a stone bottom section 108, a plate 114 positioned within the internal hollow space 102 and immediately adjacent to the stone bottom section 108, and an additional layer 109 that can be removably attached to the stone body 101 to increase the overall height/size of the artificial stone 100. FIG. 5b illustrates a top perspective view of one possible embodiment of additional layer 109, which may be comprised of the same material as body portion 101.

FIG. 5c illustrates a side perspective view of one possible embodiment of a landscaping stone 100 of the present invention having an additional plastic layer 109 attached thereto to increase the overall height/size of the stone 100, and FIG. 5d illustrates a side perspective view of one possible embodiment of a landscaping stone 100 having a plurality of additional plastic layers 1091, 1092 and related plates 114 in accordance with the disclosed architecture. The additional layer 109 is preferably placed between the first and second plates 114, such that the stick 107 is attached to the plate 114 placed on the bottom portion of the layer 109, and the stone body 101 is placed on the top of the plate 114 placed over the top portion of the layer 109 to form a complete stone structure 100 having an increased height. The various layers, plates and body portion may be fixedly attached to one another with an adhesive or removably attached via the threaded and mating engagement of the various components. In this manner, any desired height/size may be achieved by the user by simply adding or removing plates 109.

As previously stated, the artificial landscape stones 100 of the present invention can have a luminous powder coating 115 over all or a portion of its outer surface 103, such that the artificial stone 100 illuminates in the dark, and enables a user to view, for example, a pathway at night. Additionally, the artificial landscape stone 100 structure helps the soil in maintaining moisture, and prevents soil erosion. Furthermore, the artificial landscape stone 100 may further comprise an ultraviolet protection coating that protects the stone surface 103 against fading and UV damage from sunlight. Finally, it is also contemplated that the artificial landscaping stones 100 may be comprised of recycled materials, such as recycled plastics, thereby making the stones 100 environmentally friendly.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “artificial stones”, “plastic stones”, “lightweight stones”, “artificial plastic landscape stones”, “plastic landscaping stones” and “stones” are interchangeable and refer to the artificial plastic lightweight stones of the present invention. The terms “stick”, “stone mounting support stick” and “stake” also hold the same meaning as of an anchoring element present on a bottom surface of the stones and can be used replaceable for each other.

Notwithstanding the forgoing, the artificial lightweight landscape stones 100 of the present invention and their various structural components can be of any suitable size, shape, color and configuration as is known in the art without affecting the overall concept of the invention, provided that it accomplishes the above stated objectives. One of ordinary skill in the art will appreciate that the shape and size of the artificial plastic lightweight stone 100 and its various components, as shown in the FIGS. are for illustrative purposes only, and that many other shapes and sizes of the artificial relatively lightweight stone 100 are well within the scope of the present disclosure. Although dimensions of the artificial lightweight stone 100 and its components (i.e., length, width, and height) are important design parameters for good performance, the artificial lightweight stone 100 and its components may be any shape or size that ensures optimal performance during use and/or that suits user need and/or preference.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An artificial landscaping stone comprising:
a first piece of stone and a second piece of stone, wherein each of said first piece of stone and second piece of stone have a bottom section;
a support mounting stick that is attached to the bottom section of either said first piece of stone or said second piece of stone, wherein said support mounting stick has a stick tapering end and a stick securing end; and
an outer surface having a natural stone appearance.

2. The artificial landscaping stone of claim 1, wherein said stick securing end is concealed in a separate stick head compartment present in both of said first piece of stone and said second piece of stone.

3. The artificial landscaping stone of claim 1, wherein each of said first piece of stone and said second piece of stone have an internal hollow space.

4. The artificial landscaping stone of claim 1, wherein said first piece of stone and said second piece of stone are manufactured of one or more of a polyethylene, a polyvinyl chloride, a polypropylene, a polyurethane, a rubber, an epoxy resins, an unsaturated polyester resins, an acrylate, and a methacrylate.

5. The artificial landscaping stone of claim 1, wherein said outer surface is coated with a luminescent powder.

6. The artificial landscaping stone of claim 1, wherein said support mounting stick is comprised of one or more of a plastic, a wood, and a metal.

7. The artificial landscaping stone of claim 1, wherein said first piece of stone has a plurality of connectors and said second piece of stone has a plurality of slots for mating engagement with said plurality of connectors to join said first piece of stone and said second piece of stone.

8. The artificial landscaping stone of claim 7, wherein said plurality of connectors and said plurality of slots are provided on a joint portion of said first piece of stone and said second piece of stone.

9. A manufacturing process for creating an artificial stone comprising the steps of:
providing a material;
melting said material in an injection molding machine; and
injecting said material into a mold to create a first piece of stone, a second piece of stone, and a support mounting stick.

10. The manufacturing process of claim 9, wherein said first piece of stone and said second piece of stone are joined together after injecting the material into said mold.

11. The manufacturing process of claim 10, wherein said first piece of stone and said second piece of stone are permanently joined.

12. An adjustable height landscaping stone comprising:
a stone body having an outer surface defining an internal void and a bottom section;
a first plate and a second plate;
a first layer positioned at least partially between the first and second plates and immediately adjacent to the bottom section, and having an opening therein; and
a support mounting stick attached to said second plate, wherein at least a portion of the second plate is positioned in the opening of the first layer.

13. The adjustable height landscaping stone of claim 12, wherein said first layer is comprised of plastic.

14. The adjustable height landscaping stone of claim 12, wherein said first layer is attached to said second plate by a waterproof adhesive.

15. The adjustable height landscaping stone of claim 12, wherein said outer surface is coated with a luminescent powder.

16. The adjustable height landscaping stone of claim 12, wherein said outer surface is coated with an ultraviolet protection coating.

17. The adjustable height landscaping stone of claim 12 further comprising a second layer and a third plate.

18. The adjustable height landscaping stone of claim 12, wherein said support mounting stick comprises a stick securing end and a stick tapering end.

19. The adjustable height landscaping stone of claim 12, wherein said stone body further comprises a first half and a second half.

20. The adjustable height landscaping stone of claim 12, wherein said outer surface has an appearance of a natural stone.
